(19) United States
(12) Patent Application Publication
(10) Pub. No.: US 2026/0315194 A1
(43) Pub. Date: Oct. 15, 2026

(54) PRE-MILLED DENTAL ABUTMENTS WITH AN ANGULATED SCREW CHANNEL

(71) Applicant: Young Innovations, Inc., Algonquin, IL (US)

(72) Inventor: Nick GRASSEL, Port Washington, WI (US)

(21) Appl. No.: 19/643,398

(22) Filed: Apr. 9, 2026

Related U.S. Application Data
(60) Provisional application No. 63/787,454, filed on Apr. 11, 2025.

(51) Int. Cl. A61C 8/00

(52) U.S. Cl. CPC A61C 8/0068; A61C 2201/00

(57) ABSTRACT

A pre-milled dental abutment comprising an abutment head configured to removably couple to a milling machine, an abutment body disposed on the abutment head, the abutment body comprising a screw bore formed by two walls, and an opening disposed on the abutment body, opening configured to allow a dental screw to be inserted into the screw bore, and an implant-abutment connector configured to connect the pre-milled dental abutment to an implant.

### CROSS-REFERENCE TO RELATED APPLICATIONS

The present application claims the benefit of U.S. Patent Application No. 63/787,454, entitled “PRE-MILLED DENTAL ABUTMENTS WITH AN ANGULATED SCREW CHANNEL” filed on 11 Apr. 2025, which is incorporated herein by reference in its entirety.

### FIELD OF INVENTION

The present disclosure generally relates to dental prosthetics and, more specifically, to pre-milled dental abutments with angulated screw channels for connecting a dental implant to an artificial tooth during dental implant surgeries.

### BACKGROUND

Human teeth serve numerous functions. Besides assisting with the chewing of food, they also serve a purpose various other important purposes such as assisting in speech. Healthy, clean and well aligned teeth also serve cosmetic purposes.

Despite preventative methods such as frequent brushing and flossing, and drinking fluoridized or iodized water, a great majority of people generally require acute and/or chronic dental care, in varying degrees, which comprises treatment dental fillings, restorations implants, and/or prostheses to maintain good oral health. In the instance of a missing tooth, one of the routes that dentists take to restore the missing tooth is a dental implant surgery. In the dental implant surgery, an implant is usually placed in the jawbone. Once the implant has undergone osseointegration, an artificial tooth/implant crown is connected to the implant via a small, connector piece called a dental abutment.

To ensure a patient-specific and custom fit, dental abutments are generally sold in a pre-milled form. The pre-milled dental abutment is then designed and milled to a patient-specific geometry with a CAD/CAM process to generate a dental abutment that will align with the treatment plan and minimize cosmetic issues. Many of the presently available pre-milled dental abutments available contain a screw channel that is aligned upward and straight. These pose a challenge in restoring a missing tooth without any cosmetic issues. There is a need for a pre-milled abutment which allows full flexibility in being designable to any treatment plan proposed by a dentist as well as be able to restore the missing tooth without any cosmetic issues.

The present disclosure includes features to address these concerns by presenting a pre-milled abutment with angled screw channel that allows the designer to have full flexibility in following the prescribed treatment plan, provides optimal cosmetic results for the patient by providing the option to hide the screw channel and also minimize the number of elements needed for the dental restoration.

### SUMMARY

Disclosed herein are approaches for addressing various of the problems and shortcomings of the state of the art, as identified above. More particularly, disclosed herein to pre-milled dental abutments with angulated screw channels for connecting a dental implant to an artificial tooth during dental implant surgeries.

According to a first aspect of the present disclosure, there is provided a pre-milled dental abutment comprising an abutment head configured to removably couple to a milling machine, an abutment body disposed on the abutment head, the abutment body comprising a screw bore formed by two walls, and an opening disposed on the abutment body, opening configured to allow a dental screw to be inserted into the screw bore, and an implant-abutment connector configured to connect the pre-milled dental abutment to an implant.

### BRIEF DESCRIPTION OF THE DRAWINGS

FIG. 1A shows a perspective view of an exemplary aspect of a milled dental abutment.

FIG. 1B shows a cross-sectional view of the exemplary aspect of the milled dental abutment of FIG. 1A connecting a dental implant with an artificial tooth.

FIG. 1C shows a perspective view of an exemplary implementation of a pre-milled dental abutment connected to a milling machine.

FIG. 1D shows a perspective view of an exemplary implementation of a connection mechanism of the pre-milled dental abutment and the milling machine.

FIG. 2A shows a perspective view of an exemplary aspect of a pre-milled dental abutment.

FIG. 2B shows a cross-sectional view of the exemplary aspect of the pre-milled dental abutment of FIG. 2A with a dental screw in an unloaded position.

FIG. 2C shows a cross-sectional view of the exemplary aspect of the pre-milled dental abutment of FIG. 2A with a dental screw in a partially loaded position.

FIG. 2D shows a cross-sectional view of the exemplary aspect of the pre-milled dental abutment of FIG. 2A with a dental screw in a fully loaded position.

FIG. 3A shows a perspective view of an exemplary aspect of a pre-milled dental abutment.

FIG. 3B shows a cross-sectional view of the exemplary aspect of the pre-milled dental abutment of FIG. 3A.

FIG. 3C shows a cross-sectional view of the exemplary aspect of the pre-milled dental abutment of FIG. 3A with a dental screw in a fully loaded position.

FIG. 4A shows a perspective view of an exemplary aspect of a pre-milled dental abutment.

FIG. 4B shows a cross-sectional view of the exemplary aspect of the pre-milled dental abutment of FIG. 4A.

FIG. 4C shows a cross-sectional view of the exemplary aspect of the pre-milled dental abutment of FIG. 4A with a dental screw in a fully loaded position.

FIG. 5A shows a perspective view of an exemplary aspect of a pre-milled dental abutment.

FIG. 5B shows a perspective view of the exemplary aspect of the pre-milled dental abutment of FIG. 5A.

FIG. 5C shows a perspective view of the exemplary aspect of the pre-milled dental abutment of FIG. 5A with a dental screw in a fully loaded position.

FIG. 5D shows a perspective view of the exemplary aspect of the pre-milled dental abutment of FIG. 5A with a dental screw in an unloaded position.

FIG. 5E shows a perspective view of the exemplary aspect of the pre-milled dental abutment of FIG. 5A with a dental screw in an unloaded position.

FIG. 6A shows a perspective view of an exemplary aspect of a stock abutment connecting an artificial tooth to an implant.

FIG. 6B shows a perspective view of the exemplary aspect of stock abutment of FIG. 6A.

FIG. 6C shows cross-sectional view of the exemplary aspect of stock abutment of FIG. 6A.

FIGS. 7A-7I show perspective views of an exemplary aspect of a pre-milled dental abutment.

FIGS. 8A-8H show perspective views of an exemplary aspect of a pre-milled dental abutment.

FIGS. 9A-9G show perspective views of an exemplary aspect of a pre-milled dental abutment.

FIGS. 10A-10I show perspective views of an exemplary aspect of a pre-milled dental abutment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description may include specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

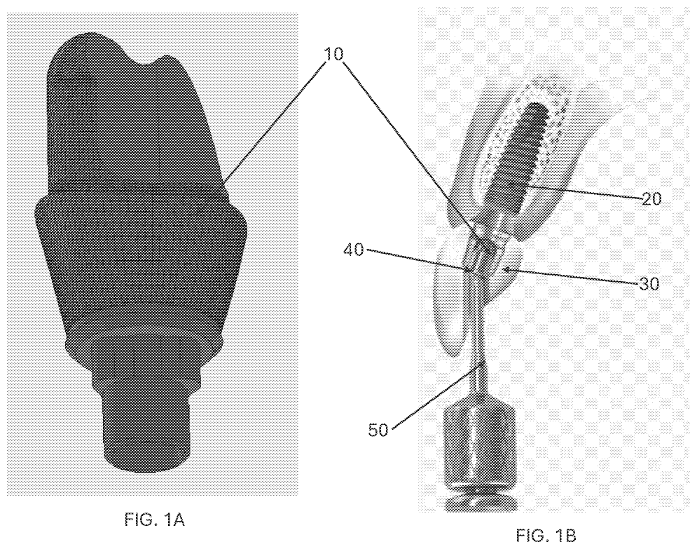

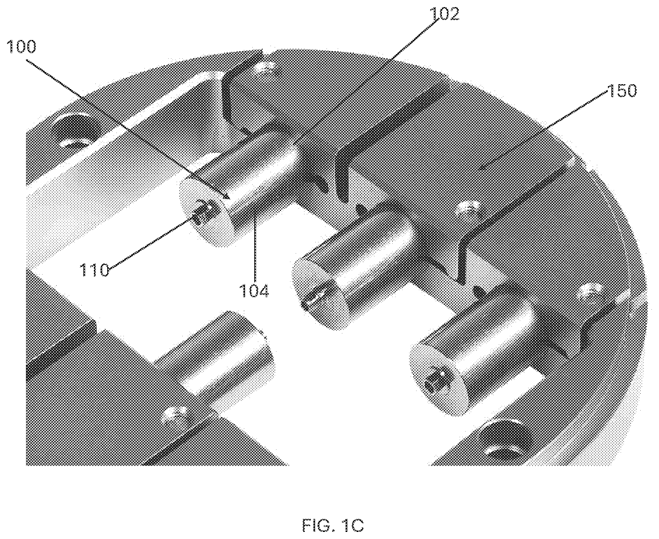

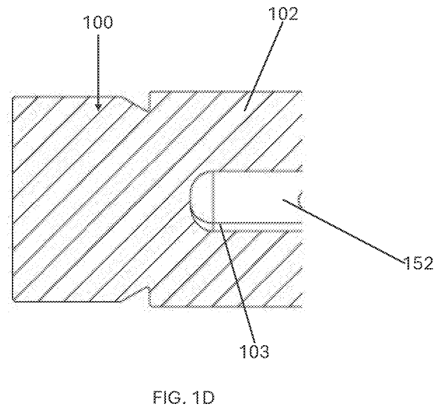

Referring to the drawings, FIGS. 1A and 1B present perspective views of an exemplary aspect of a milled dental abutment 10 connecting an artificial tooth 30 to an implant 20 via a dental screw 40. In this aspect of the milled dental abutment 10, the milled dental abutment has been milled to be patient and treatment plan specific to ensure success of the treatment plan as well as being cosmetically viable. Referring to FIG. 1A, the milled dental abutment 10 can be attached to the implant 20 via the dental screw 40 using a driver 50. In the aspect of the milled dental abutment shown in FIG. 1B, the milled dental abutment 10 is used to connect an artificial incisor tooth 30 to the implant 20 with the dental screw 40 via the driver 50.

Referring to FIG. 1C, a perspective view of an exemplary aspect of a pre-milled dental abutment 100 (prior to milling to form a milled dental abutment 10 as presented in FIGS. 1A-1B) connected to a milling machine 150 is presented. FIG. 1C also presents the primary structural components of the pre-milled dental abutment 100. These include an abutment head 102, an abutment body 104 coupled to the abutment head 102, and a connector 110 disposed on the abutment body 104. In some aspects, the pre-milled abutment 100 can also comprise at least one chamfer (not shown in FIG. 1C) disposed on the abutment body 104 (proximal to the abutment head 102) configured to increase accessibility for the driver 50 to torque the dental screw 40 into the implant 20.

In this aspect shown in FIG. 1C, the pre-milled dental abutment 100 is configured to be connected to the milling machine 150 via the abutment head 102 while the pre-milled dental abutment 100 is milled to form the milled dental abutment 10 with patient specific geometry as shown in FIGS. 1A-1B.

Referring to FIG. 1D, a perspective view of an exemplary implementation of a connection mechanism of the pre-milled dental abutment 100 and the milling machine 150 is shown. In this implementation, the pre-milled dental abutment 100 can be configured to be connected to the milling machine 150 via a protrusion 152 disposed on the milling machine 150. In this implementation, the abutment head 102 of pre-milled dental abutment 100 can comprise an aperture 103 configured to receive the protrusion 152 and connect the pre-milled dental abutment 100 to the milling machine 150. In some implementations, the protrusion 152 disposed on the milling machine 150 is formed of titanium or titanium-based alloy.

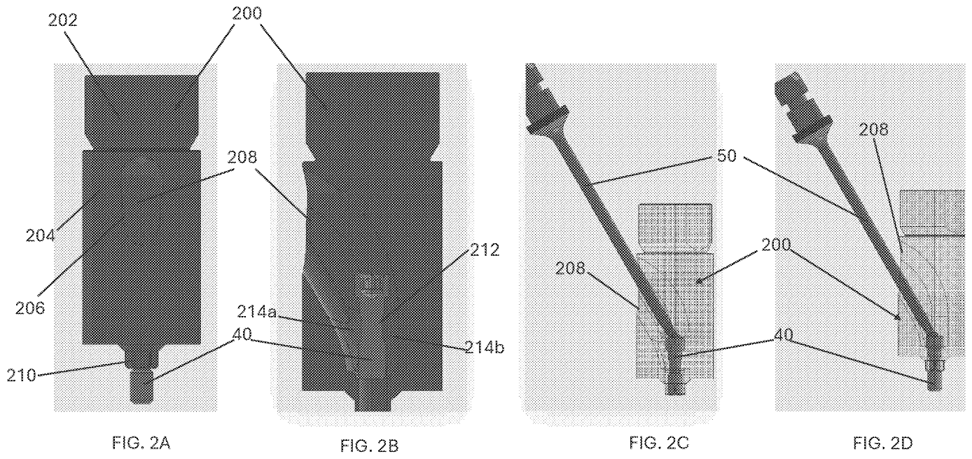

Referring to FIGS. 2A-2D, a perspective view and cross-sectional views of an exemplary aspect of a pre-milled dental abutment 200 (prior to milling to form a milled dental abutment 10 as presented in FIGS. 1A-1B) is presented. FIG. 2A also presents the primary structural components of the pre-milled dental abutment 200. These include an abutment head 202, an abutment body 204 coupled to the abutment head 202, an opening 206 and an angular screw channel 208 disposed on the abutment body 204, and abutment-implant connector 210 disposed on the abutment body 204.

In the aspect of the pre-milled dental abutment 200 shown in FIGS. 2A-2D, the dental screw 40 can be guided into the abutment body 204 via the angular screw channel 208 and into a screw bore 212 created by walls 214a and 214b. The walls 214a and 214b can be configured to limit the travel of the dental screw 40. In the aspect of the pre-milled abutment 200 shown in FIGS. 2C and 2D, the dental screw 40 can be torqued into implant 20 through the screw bore 212 and the abutment-implant connector 210 via the driver 50.

In the aspects presented in FIGS. 2C and 2D, the screw channel 208 can be designed to provide clearance to the driver 50 with a minimum angle at which the dental screw 40 can be accessed by the driver 50 throughout the travel of the dental screw 40 into the implant such as in the partially loaded position (FIG. 2C) and fully-loaded position (FIG. 2D). In some implementations, the minimum angle at which the dental screw 40 can be accessed by the driver 50 is 30 degrees. In other implementations, the minimum angle can comprise a range of angle between 30 degrees and 90 degrees. In some implementations, the abutment-implant connector 210 can also be configured to be tightened to limit the travel of the dental screw 40 into the implant 20. In some aspects, the screw channel 208 can be designed to travel half-way through the pre-milled dental abutment 200.

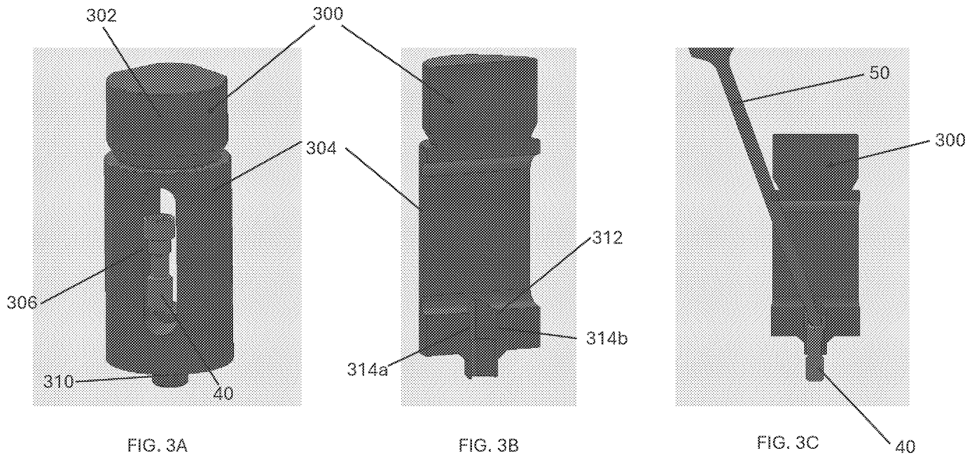

Referring to FIGS. 3A-3C, a perspective view and cross-sectional views of another exemplary aspect of a pre-milled dental abutment 300 (prior to milling to form a milled dental abutment 10 as presented in FIGS. 1A-1B) is presented. FIG. 3A also presents the primary structural components of the pre-milled dental abutment 300. These include an abutment head 302, an abutment body 304 coupled to the abutment head 302, an opening slot 306 configured to travel throughout a width of the abutment body 304 and abutment-implant connector 310 disposed on the abutment body 304.

In the aspect of the pre-milled dental abutment 300 shown in FIGS. 3A-3C, the dental screw 40 can be guided into the abutment body 304 via the opening slot 306 and into a screw bore 312 created by walls 314a and 314b. The walls 314a and 314b can be configured to limit the travel of the dental screw 40. In the aspect of the pre-milled abutment 300 shown in FIG. 3C, the dental screw 40 can be torqued into implant 20 through the screw bore 312 and the abutment-implant connector 310 via the driver 50.

In the aspects presented in FIGS. 3A-3C, the opening slot 306 can be configured to provide clearance to the driver 50. The screw bore 312 can be designed to have a minimum angle at which the dental screw 40 can be accessed by the driver 50. In some implementations, the minimum angle at which the dental screw 40 can be access by the driver 50 is 0 degrees. In other implementations, the minimum angle can comprise a range of angles between 0 degrees and 20 degrees. In some implementations, the abutment-implant connector 310 can also be configured to be tightened to limit the travel of the dental screw 40 into the implant 20. In some aspects, the opening slot 306 can be configured to have a minimum height to allow clearance for the driver 50.

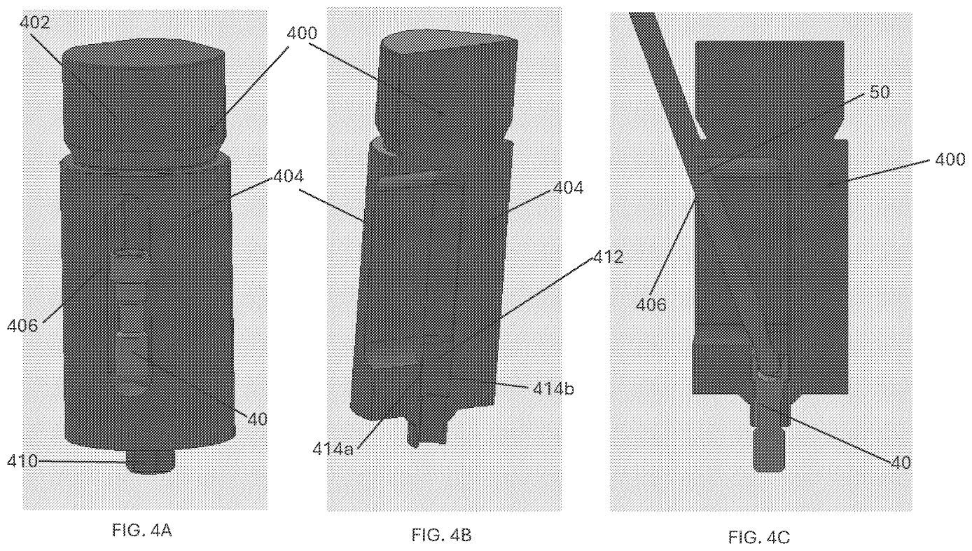

Referring to FIGS. 4A-4C, a perspective view and cross-sectional views of another exemplary aspect of a pre-milled dental abutment 400 (prior to milling to form a milled dental abutment 10 as presented in FIGS. 1A-1B) is presented. FIG. 4A also presents the primary structural components of the pre-milled dental abutment 400. These include an abutment head 402, an abutment body 404 coupled to the abutment head 402, an opening slot 406 and abutment-implant connector 410 disposed on the abutment body 404. In the aspect presented in FIGS. 4A-4C, the opening slot 406 is configured to travel partially through a width of the abutment body 404. In some aspects, the opening 406 is configured to travel half-way through the width of the abutment body 404. In some aspects, the opening 406 is configured to travel below half-way through the width of abutment body 404.

In the aspect of the pre-milled dental abutment 400 shown in FIGS. 4A-4C, the dental screw 40 can be guided into the abutment body 404 via the opening slot 406 and into a screw bore 412 created by walls 414a and 414b. The walls 414a and 414b can be configured to limit the travel of the dental screw 40. In the aspect of the pre-milled abutment 400 shown in FIG. 4C, the dental screw 40 can be torqued into implant 20 through the screw bore 412 and the abutment-implant connector 410 via the driver 50.

In the aspects presented in FIGS. 4A-4C, the opening slot 406 can be configured to provide clearance to the driver 50. The screw bore 412 can be designed to have a minimum angle at which the dental screw 40 can be accessed by the driver 50. In some implementations, the minimum angle at which the dental screw 40 can be access by the driver 50 is 20 degrees. In some implementations, the abutment-implant connector 410 can also be configured to be tightened to limit the travel of the dental screw 40 into the implant 20. In some aspects, the opening slot 406 can be configured to have a minimum height to allow more clearance for the driver 50.

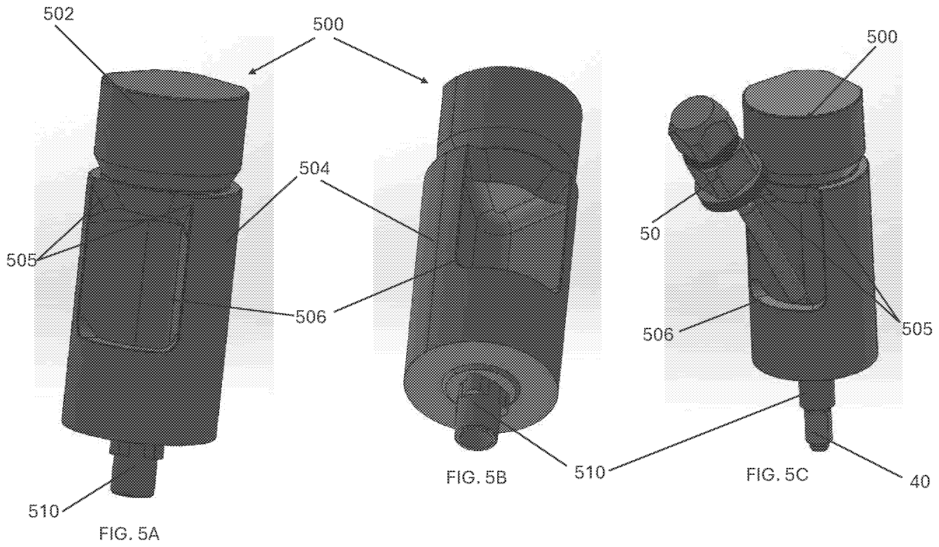

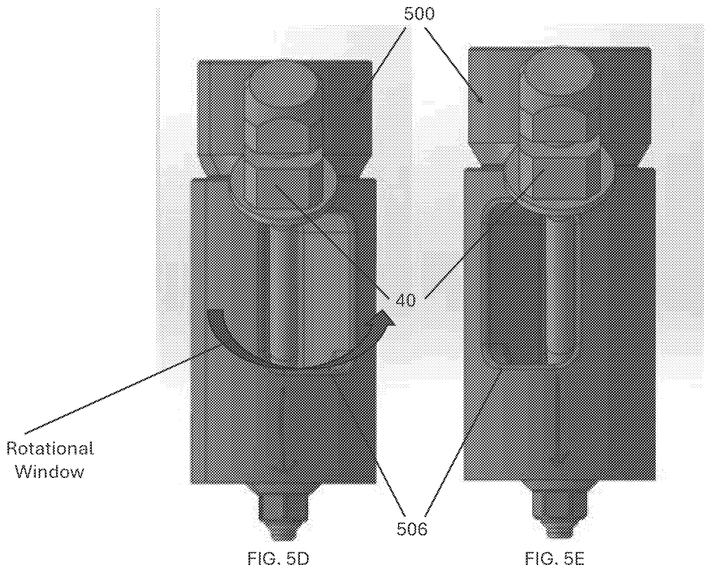

Referring to FIGS. 5A-5C, cross-sectional views of another exemplary aspect of a pre-milled dental abutment 500 (prior to milling to form a milled dental abutment 10 as presented in FIGS. 1A-1B) is presented. FIG. 5A also presents the primary structural components of the pre-milled dental abutment 500. These include an abutment head 502, an abutment body 504 coupled to the abutment head 502, a screw insertion window 506 and abutment-implant connector 510 disposed on the abutment body 504.

In the aspect presented in FIGS. 5A-5C, the screw insertion window 506 is configured to travel partially through the abutment body 504. In some aspects, the screw insertion window 506 is configured to travel half-way through the abutment body 504. In some aspects, the screw insertion window 506 is configured to travel below half-way through the abutment body 504. The screw insertion window 506 can be configured to have pre-determined dimensions. In some aspects, the screw insertion window 506 can be configured to have a height, measured from the abutment-implant connector 510 to a top of the screw insertion window 506, such that post-milling the milled-abutment 10 (such as in FIG. 1A) will have open and free top area configured to receive the artificial tooth 30. In some aspects, the screw insertion window 506 can be designed to have the height to be at least 10 mm. In some aspects, the screw insertion window 506 has a height of 14 mm.

In the aspect of the pre-milled dental abutment 500 shown in FIGS. 5A-5C, the dental screw 40 can be guided into the abutment body 504 via the screw insertion window 506 and into a screw bore 512 created by walls 514a and 514b (not shown in FIGS. 5A-5C). The walls 514a and 514b can be configured to limit the travel of the dental screw 40. In the aspect of the pre-milled abutment 500 shown in FIG. 5C, the dental screw 40 can be torqued into implant 20 through the screw bore 512 and the connector 510 via the driver 50. In the aspect of the pre-milled dental abutment 500 as shown in FIG. 5C, the abutment body 504 can comprise at least one chamfer 505 proximal to the abutment head 502, The at least one chamfer 505 can be configured to provide increased clearance and accessibility to the driver 50 to torque the dental screw 40, through the screw bore 512 and the connector 510, into the implant 20.

Referring to FIGS. 5D-5E, perspective views of the exemplary aspect of the pre-milled dental abutment 500 with a dental screw 40 in an unloaded position is shown. In this aspect, the screw insertion window 506 can be configured to provide multi-dimensional clearance to the dental screw 40 (via the driver 50). In some implementations, the screw insertion window 506 can be a rotational window configured to span between 15 degrees to 90 rotational degrees that encompasses the entire implant geometry within. In this implementation, the screw bore 512 can be designed to placed anywhere with this rotational window as shown in FIGS. 5D and 5E. In some implementations, the angle at which the dental screw 40 can be inserted is between 0-45 degrees. The driver 50 can be configured to insert the dental screw 40 in the screw bore 512. In some implementations, the connector 510 can also be configured to be tightened to limit the travel of the dental screw 40 into the implant 20.

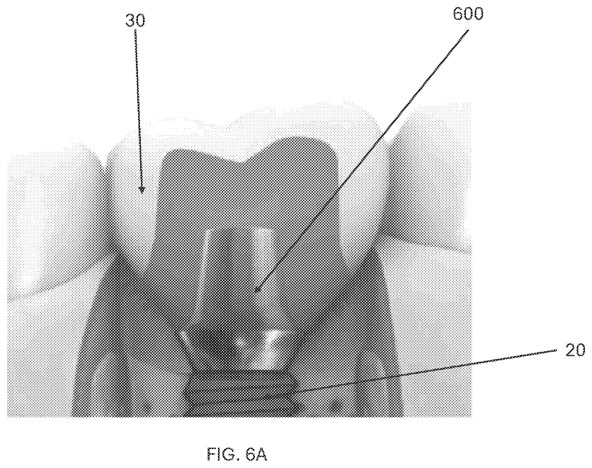

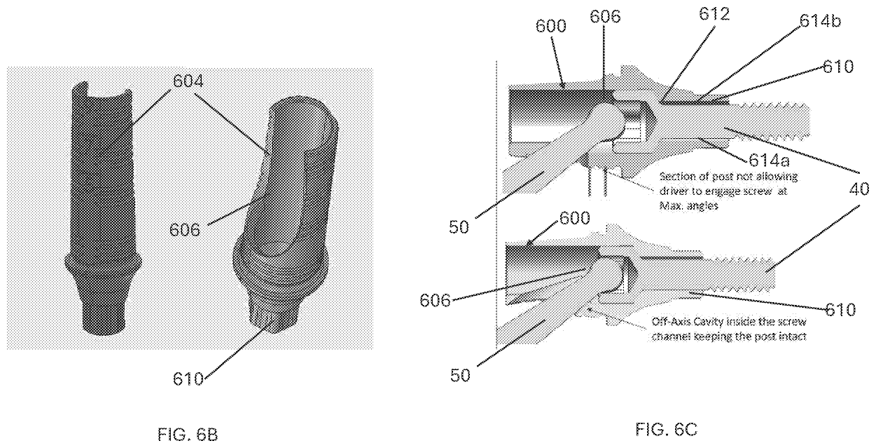

Referring to the drawings, FIG. 6A present a perspective view of an exemplary aspect of a stock abutment 600 connecting an artificial tooth 30 to an implant 20. In this aspect, the pre-milled dental abutment 600 can be a stock abutment that can be configured to be used with most implants 20 without the need for milling. In this aspect, the stock abutment 600 can be configured to have generic geometries that can give a cheaper alternative to a custom-shaped milled dental abutment 10 as shown in FIGS. 1A and 1B. Referring to FIG. 6A, the stock abutment 600 can be attached to the implant 20 via the dental screw 40 (not shown in FIG. 6A) using a driver 50.

Referring to FIGS. 6B-6C, a perspective view and a cross-sectional view of the exemplary aspect of stock abutment 600 of FIG. 6A is presented. FIG. 6B also presents the primary structural components of the stock abutment 600. These include an abutment body 604, a screw insertion window 606 and abutment-implant connector 610 disposed on the abutment body 604. In the aspect presented in FIGS. 6B-6C, the screw insertion window 606 is configured to travel partially through the abutment body 604. Unlike the pre-milled abutment presented above, the stock abutment 600 is configured to not require milling and does not have an abutment head configured for connecting with a milling machine. The screw insertion window 606 can be configured to have pre-determined dimensions that is compatible with most implant-artificial tooth cases needed by patient.

In the aspect of the stock abutment 600 shown in FIG. 6C, the dental screw 40 can be guided into the abutment body 604 via the screw insertion window 606 and into a screw bore 612 created by walls 614a and 614b. The walls 614a and 614b can be configured to limit the travel of the dental screw 40. In the aspect of the pre-milled abutment 600 shown in FIG. 6C, the dental screw 40 can be torqued into implant 20 through the screw bore 612 and the abutment-implant connector 610 via the driver 50.

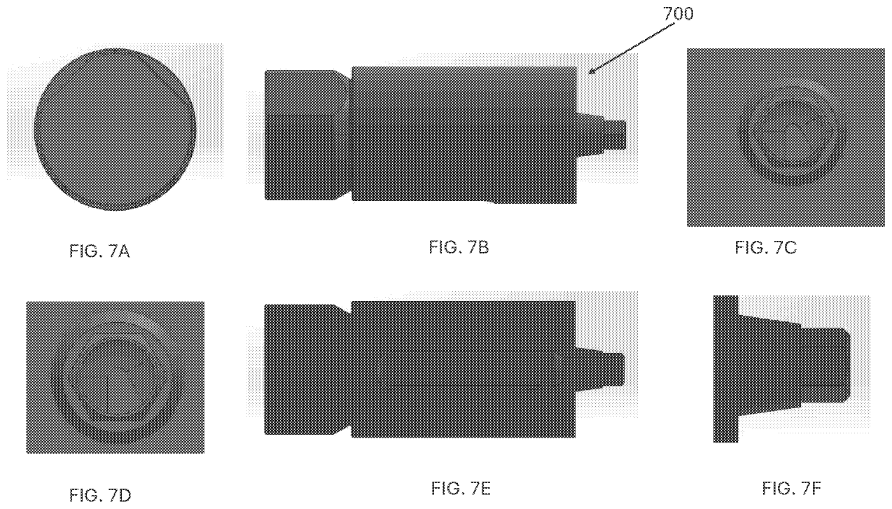

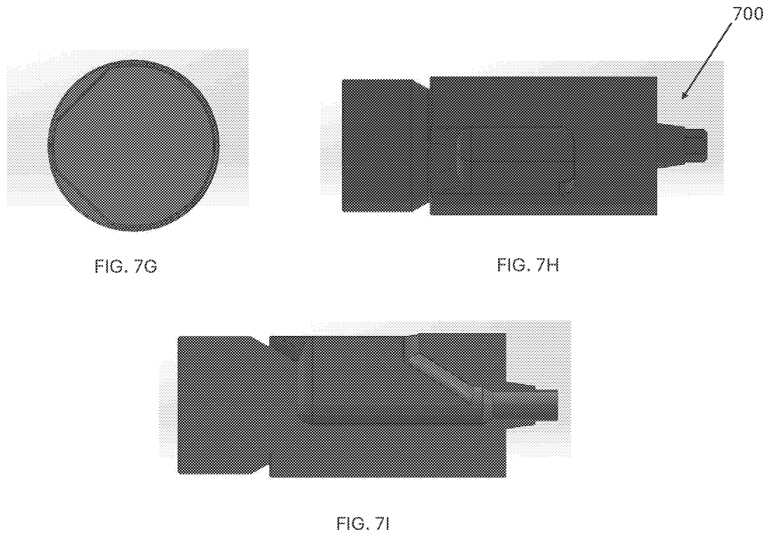

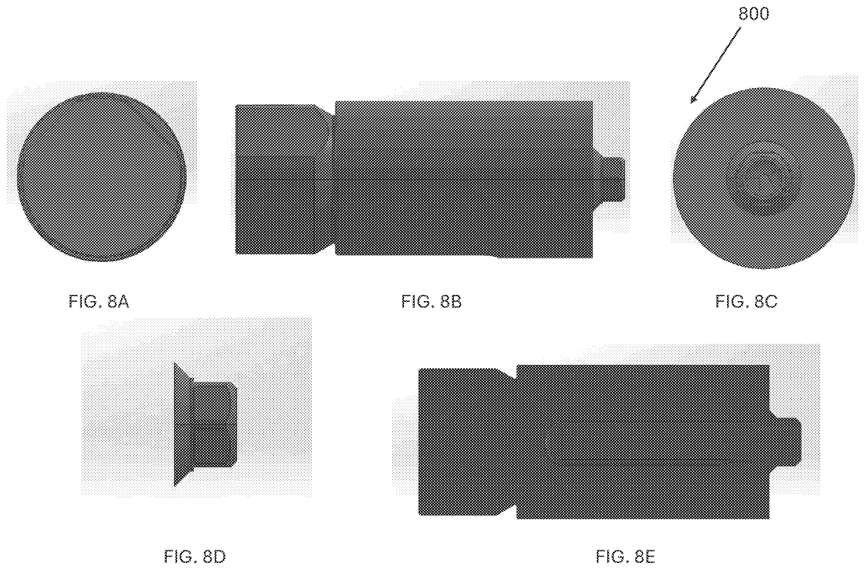

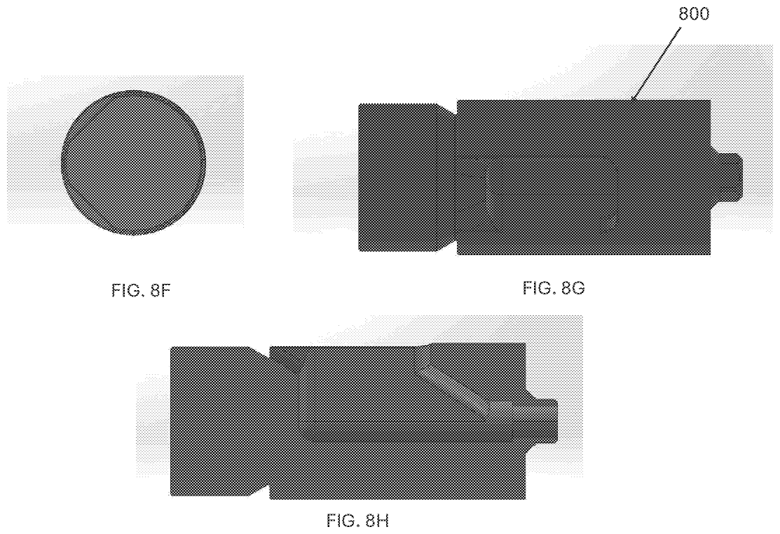

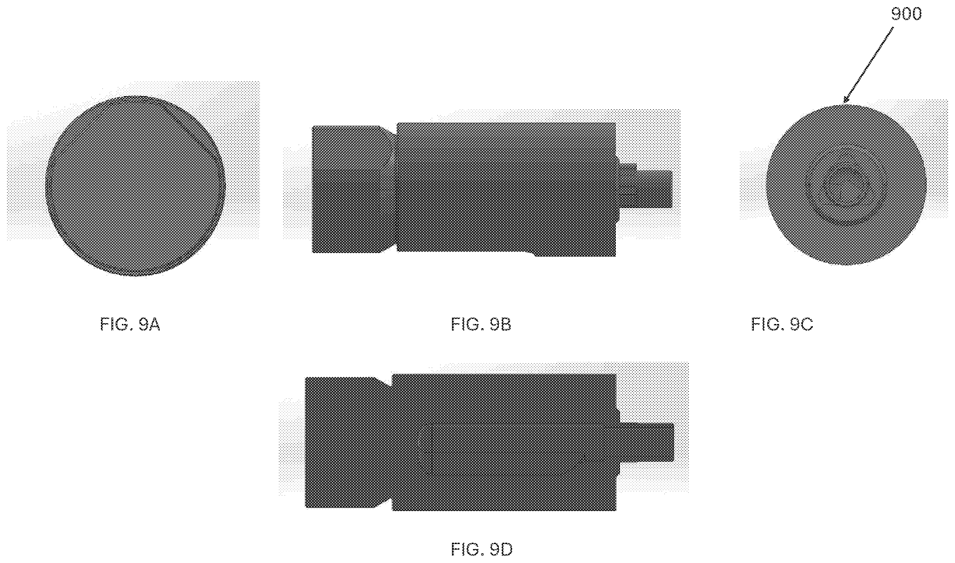

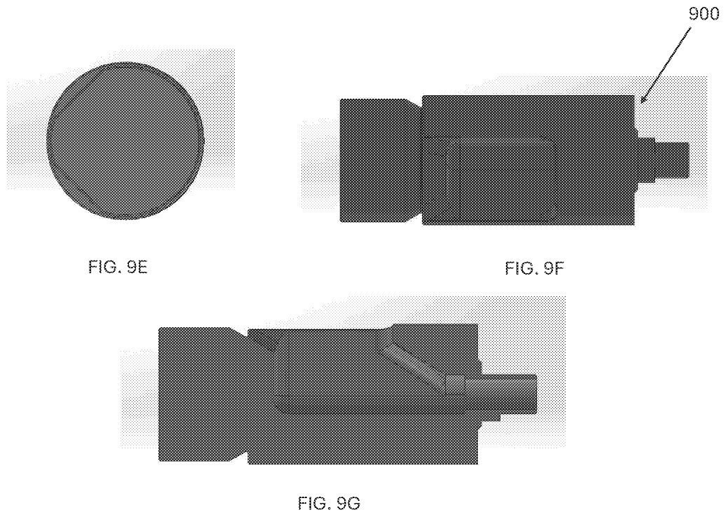

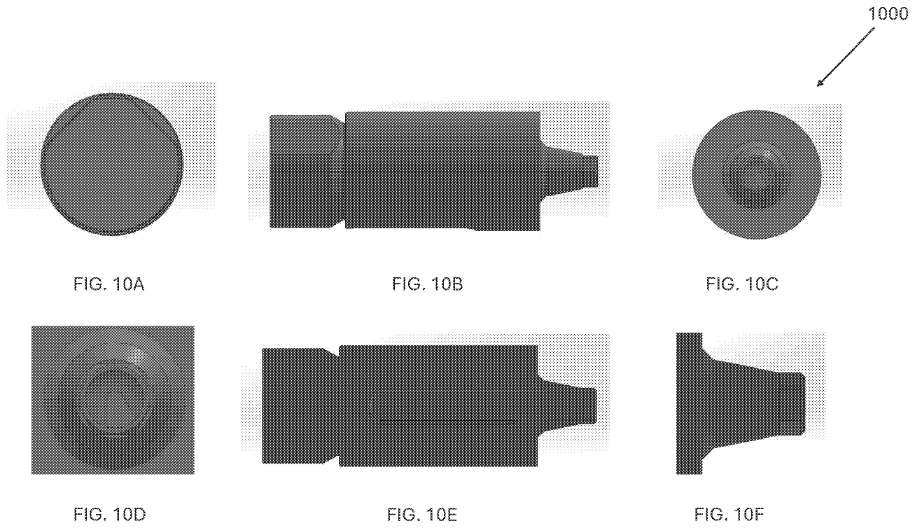

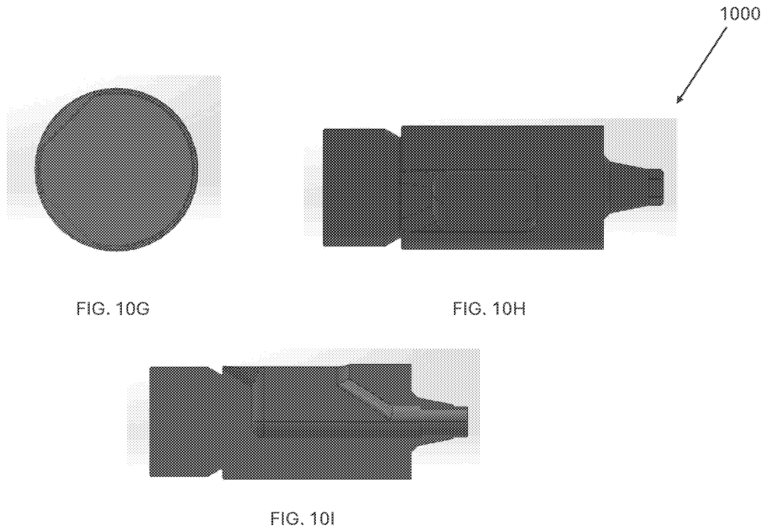

Referring to the drawings, FIGS. 7A-7I show perspective views of an exemplary aspect of a pre-milled dental abutment 700. Referring to the drawings, FIGS. 8A-8H show perspective views of an exemplary aspect of a pre-milled dental abutment 800. Referring to the drawings, FIGS. 9A-9G show perspective views of an exemplary aspect of a pre-milled dental abutment 900. Referring to the drawings, FIGS. 10A-10I show perspective views of an exemplary aspect of a pre-milled dental abutment 1000.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It may be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim.

What is claimed is:

1. A pre-milled dental abutment comprising:
an abutment head;
an abutment body disposed on the abutment head, the abutment body comprising:
a screw bore formed by two walls; and
an opening disposed on the abutment body, opening configured to allow a dental screw to be inserted into the screw bore; and
a connector configured to connect the pre-milled dental abutment to an implant via the dental screw.

2. The pre-milled dental abutment of claim 1, wherein the opening on the abutment body is a screw insertion window configured to receive the dental screw.

3. The pre-milled dental abutment of claim 2, wherein the screw insertion window is a rotational windows configured to span between 15 and 90 rotational degrees.

4. The pre-milled dental abutment of claim 3, wherein the dental screw can be inserted into the screw bore at an angle between 0 and 45 degrees.

5. The pre-milled dental abutment of claim 4, wherein the dental screw can be inserted into the screw bore via a driver.

6. The pre-milled dental abutment of claim 2, wherein the screw insertion window has a height of at least 10 mm, wherein the height is a distance between the connector and a top of the screw insertion window.

7. The pre-milled dental abutment of claim 3, wherein the screw insertion window has a height of 14 mm.

8. The pre-milled dental abutment of claim 2, wherein the screw insertion window is configured to travel throughout a width of the abutment body.

9. The pre-milled dental abutment of claim 2, wherein the screw insertion window is configured to travel half-way through a width of the abutment body.

10. The pre-milled dental abutment of claim 2, wherein the screw insertion window is configured to travel less than half-way through a width of the abutment body.

11. The pre-milled dental abutment of claim 1, wherein the abutment head is configured to connect the pre-milled dental abutment to a milling machine.

12. The pre-milled dental abutment of claim 11, wherein the abutment head comprises an aperture configured to receive a protrusion disposed on the milling machine to connect the pre-milled dental abutment to the milling machine.

13. The pre-milled dental abutment of claim 12, wherein the protrusion is made of titanium or a titanium-based alloy.

14. The pre-milled dental abutment of claim 5, wherein abutment body further comprises at least one chamfer configured to increase accessibility of the driver to torque the dental screw/

15. A stock dental abutment configured to removably couple to an implant, the stock dental abutment comprising:
an abutment body comprising:
a screw bore formed by two walls; and
an opening disposed on the abutment body, opening configured to allow a dental screw to be inserted into the screw bore; and
a connector configured to connect the pre-milled dental abutment to the implant.

16. The stock dental abutment of claim 15, wherein the opening on the abutment body is a screw insertion window configured to receive the dental screw.

17. The stock dental abutment of claim 16, wherein the screw insertion window is a rotational windows configured to span between 15 and 90 rotational degrees.

18. The stock dental abutment of claim 17, wherein the dental screw can be inserted into the screw bore at an angle between 0 and 45 degrees.

19. The stock dental abutment of claim 18, wherein the dental screw can be inserted into the screw bore via a driver.

20. The stock dental abutment of claim 15, wherein the stock dental abutment is configured to directly couple to the implant without need for milling.
